(19) United States
(12) Patent Application Publication
(10) Pub. No.: US 2020/0370352 A1
(43) Pub. Date: Nov. 26, 2020

(54) IMPROVEMENTS IN DAMPED HINGE ASSEMBLIES

(71) Applicant: TITUS D.O.O. DEKANI, Dekani (SI)

(72) Inventor: David Pecar, Pobegi (SI)

(73) Assignee: TITUS D.O.O. DEKANI, Dekani (SI)

(21) Appl. No.: 16/969,170

(22) PCT Filed: Feb. 11, 2019
(86) PCT No.: PCT/EP2019/053342

§ 371 Date: Aug. 11, 2020

(30) Foreign Application Priority Data
Feb. 16, 2018 (GB) 1802532.0

(51) Int. Cl. E05D 11/08; A47K 13/12; E05D 3/02; E05F 3/20

(52) U.S. Cl. CPC E05D 11/081; A47K 13/12; E05D 3/02; E05F 3/20; E05Y 2900/614; E05Y 2201/264; E05Y 2201/266; E05Y 2201/638; E05Y 2201/256

(57) ABSTRACT

A damped hinge assembly for mounting a first member for rotational movement relative to a base member about a hinge axis is provided. The assembly includes a first linearly acting damping device, and first camming means for converting rotational movement of the first member in a first direction into linear actuation of the first damping device to cause it to impart a damped resistive force to the first member over at least part of its movement in said first direction. The first damping device is mounted with its linear axis coincident with the hinge axis, with the first damping device acting as a fulcrum for said rotational movement of the first member.

### BACKGROUND

Damped hinge assemblies may be used for mounting lids and seats on toilets and for other applications.

### SUMMARY

The invention provides a damped hinge assembly for mounting a first member for rotational movement relative to a second member about a hinge axis, the assembly comprising a linearly acting damping device, and camming means for converting rotational movement of the first member in a first direction into linear actuation of the damping device to cause the damping device to impart a damped resistive force to the first member over at least part of its movement in said first direction, wherein the damping device is mounted with its linear axis coincident with the hinge axis, with the damping device acting as a fulcrum for said rotational movement of the first member.

By way of example, embodiments of the invention will now be described with reference to the accompanying drawings, in which:

### BRIEF DESCRIPTION OF DRAWINGS

FIG. 1 shows a lid and seat for a toilet to incorporate a damped hinge assembly according to the invention,

FIG. 2 shows the lid and seat of FIG. 1 in position on a toilet,

FIG. 3 is a sectional view along lines A-A of FIG. 2,

FIG. 4 shows a form of damping device for the lid,

FIG. 5 shows a form of damping device for the seat,

FIGS. 6a and 6b show alternative forms of post,

FIG. 7 shows an alternative form of damping device for the lid,

FIG. 8 shows another alternative form of damping device,

FIG. 9 is a sectional view through part of the hinge assembly showing the damping device for the lid,

FIG. 10 is a sectional view through part of the hinge assembly showing the damping device for the seat,

FIGS. 11a and 11b are sectional views along the lines D-D and B-B of FIG. 3, and

FIGS. 11c and 11d are sectional views along the lines C-C and E-E of FIG. 3.

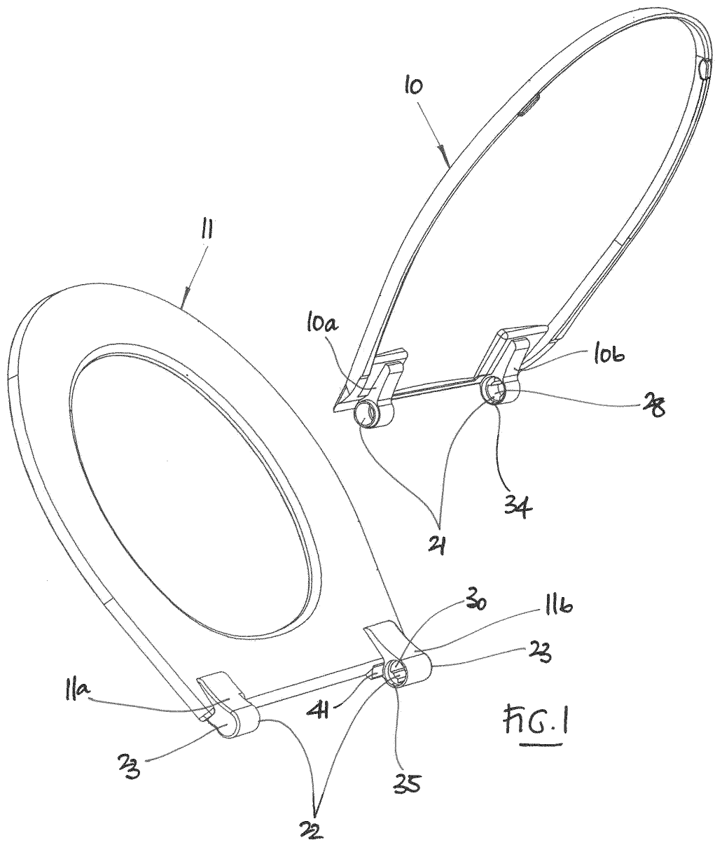

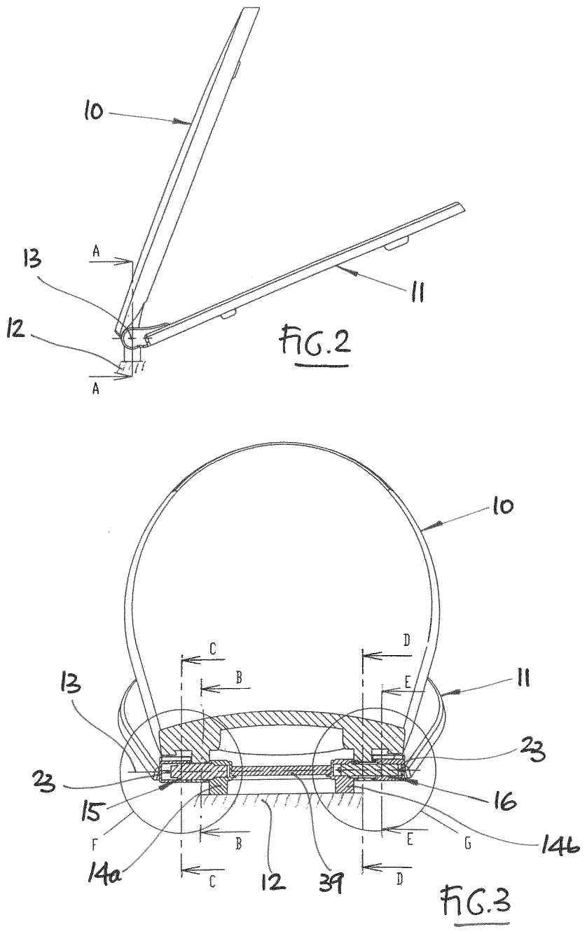

### DETAILED DESCRIPTION

Specific embodiments of the disclosed technology will now be described in detail with reference to the accompanying figures. Like elements in the various figures may be denoted by like reference numerals and/or like names for consistency.

The following detailed description is merely exemplary in nature, and is not intended to limit the disclosed technology or the application and uses of the disclosed technology. Furthermore, there is no intention to be bound by any expressed or implied theory presented in the preceding technical field, background, brief summary or the following detailed description.

In the following detailed description of embodiments of the disclosed technology, numerous specific details are set forth in order to provide a more thorough understanding of the disclosed technology. However, it will be apparent to one of ordinary skill in the art that the disclosed technology may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

The damped hinge assembly seen in the drawings is for mounting a lid 10 and a seat 11 on a toilet 12. The lid 10 and the seat 11 are mounted onto the toilet 12 for rotational movement about a horizontal hinge axis 13 via a pair of spaced apart posts 14a, 14b which are anchored to the toilet 12 by threaded fasteners in known manner. The arrangement enables both the lid 10 and the seat 11 to be pivotable between a lower, generally horizontal position resting on the toilet 12 and a raised position, generally slightly beyond vertical and resting against a cistern or wall or the like.

The assembly is arranged to provide a damped resistive force to counter the pivotal movement of both the lid 10 and seat 11 as they move under gravity from their raised position to their lower position. This is intended to avoid possible damage that could otherwise occur if the lid 10 and/or seat 11 were accidentally allowed to fall freely onto the toilet 12. Preferably, however, little or no damping resistance is provided to opening movement of the lid and seat towards their raised position.

The damped resistive force is provided by means of damping devices 15, 16, and in this assembly there are two such devices: one (15) for the lid 10 and the other (16) for the seat 11. The damping devices 15, 16 are designed to be able to operate independently of one another, ie to provide a damped resistive force to the closing movement of the lid 10 and the seat 11 whether they are moving singly or together.

The damping device 15 for the lid 10 is seen more clearly in FIG. 4. It is in the form of a linearly acting piston and cylinder type damper, with a piston (not seen) attached to a piston rod 17 mounted for reciprocal movement within a cylinder 18 containing damping fluid, with a spring (not seen) biassing the piston rod towards its extended position.

The damping device 16 for the seat 11 is seen more clearly in FIG. 5. Like the damping device 15, it is also in the form of a linearly acting piston and cylinder type damper, with a piston (not seen) attached to a piston rod 19 mounted for reciprocal movement within a cylinder 20 containing damping fluid, with a spring (not seen) biassing the piston rod towards its extended position.

The lid 10 and the seat 11 are formed with integral pairs of spaced apart hinge blocks 10a, 10b and 11a, 11b. These are each provided with axially aligned bores 21, 22 for engaging the damping devices 15, 16. As seen in FIG. 3, the damping devices 15, 16 extend through the bores 21, 22 of the hinge blocks 10a, 10b of the lid 10 and 11a, 11b of the seat 11 and into engagement with the posts 14a, 14b, thus effectively acting in the manner of a hinge pin in pivotally mounting the lid and seat on the toilet.

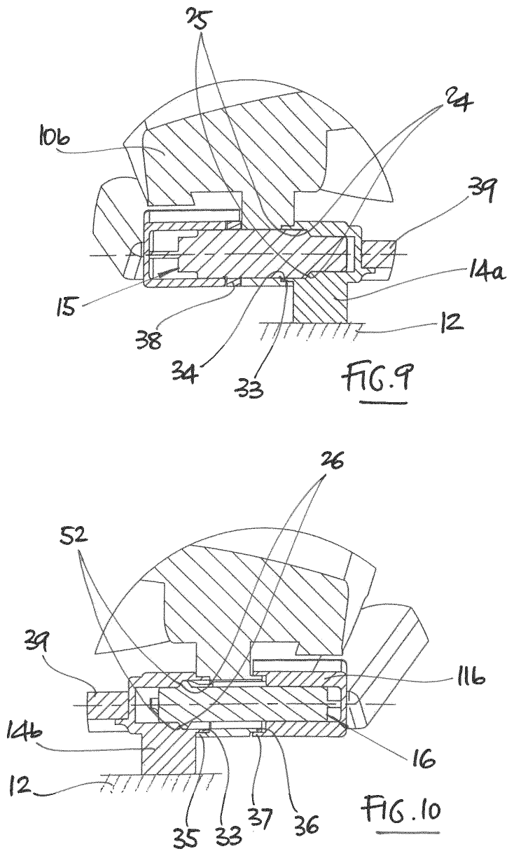

In this case, the hinge blocks 11a, 11b of the seat 11 are designed to fit outside the hinge blocks 10a, 10b of the lid 10, with their bores 22 closed off at their outer axial extremities by cover caps 23. As will be seen in FIGS. 9 and 10, the arrangement is that the free end of the piston rods 17, 19 of the damping devices 15, 16 will abut against the inside of respective cover caps 23. However, the hinge blocks could of course be arranged the other way round, or even in a staggered formation. It would also be possible to arrange the pivotal mountings of the lid and seat differently with respect to the posts, for example by locating the posts in between the respective hinge blocks of the lid and seat.

The manner of mounting of the damping devices 15, 16 enables both their rotational movement and their axial displacement relative to the posts 14a, 14b. A movement converting mechanism acting between each damping device 15, 16 and its respective post 14a, 14b operates to cause axial displacement of the damping device in response to its rotational movement.

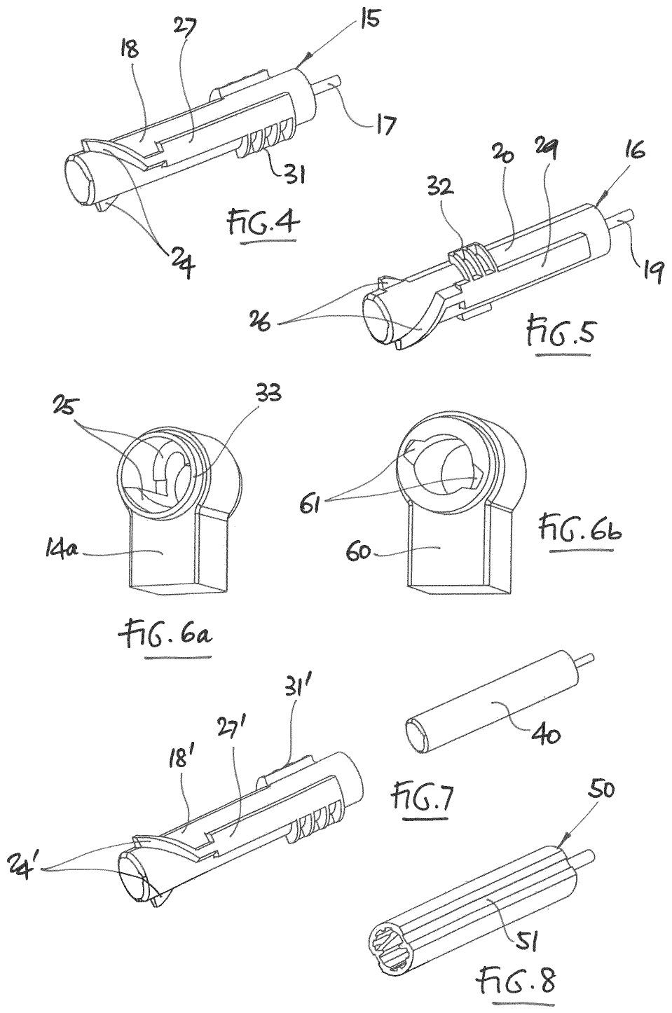

The movement converting mechanism for the damping device 15 seen in FIG. 4 comprises a pair of camming surfaces 24 extending helically around the outside of the cylinder 18. These are arranged to engage with a corresponding pair of camming surfaces 25 extending helically around the inner bore of its respective post 14a, as seen in FIG. 6a. Upon rotation of the damping device 15, the camming surfaces 24 on the cylinder 18 will ride along the camming surfaces 25 in the post 14a, thus causing axial displacement of the damping device.

The movement converting mechanism for the damping device 16 seen in FIG. 5 likewise comprises a pair of camming surfaces 26 extending helically around the outside of the cylinder 20. These are arranged to engage with a corresponding pair of camming surfaces 52 extending helically around the inner bore of its respective post 14b. In similar manner, upon rotation of the damping device 16, the camming surfaces 26 on the cylinder 20 will ride along the camming surfaces 52 in the post 14b, thus causing axial displacement of the damping device.

This arrangement of opposing engaged camming surfaces is effective in transferring forces through the movement converting mechanism. However, it means that the camming surfaces must have a constant pitch. In the alternative, it might be possible to arrange for there to be just one camming surface, with this being engageable by a follower, such as a pin. In this case, it would be possible to provide for a variable pitch. The term “generally helically” used herein is intended to encompass this possibility. In practice, this would make it possible to provide for the magnitude of the damped resistance being provided by the damping device to vary over the course of movement of the lid and/or seat.

It will be noted in the arrangement described above that when the lid and/or seat are moved to their raised position, the damping devices are returned to their extended condition by means of their springs. As an alternative, it may be considered preferable for this return function to be performed mechanically. This would be possible with the alternative form of post 60 seen in FIG. 6b. In this case, the bore of the post 60 is provided with an opposing pair of helically extending grooves 61. These grooves 61 are designed to slidingly receive the helically extending ribs that form the camming surfaces 24, 26 on the damping devices 15, 16. The arrangement will ensure that rotation of each damping device 15, 16 relative to the post 60 will automatically cause relative axial displacement, in the manner of a screw-threaded engagement.

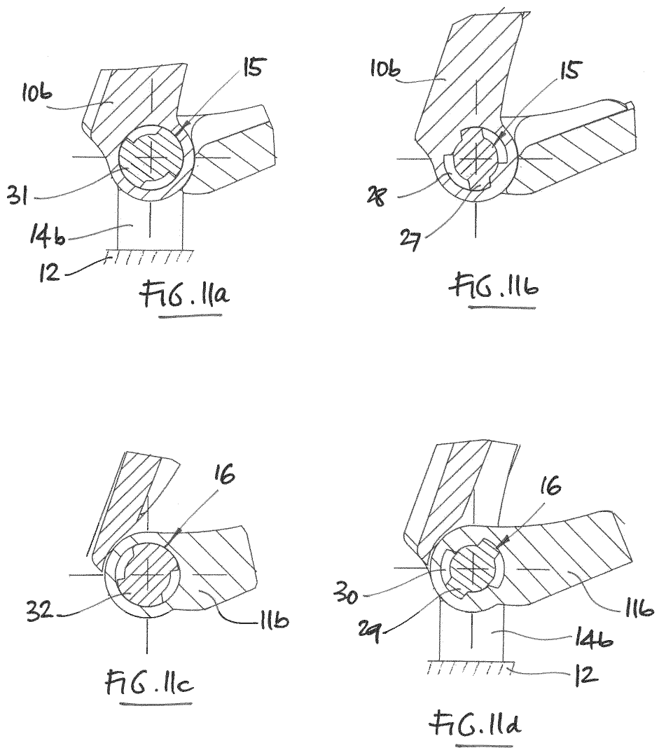

The damping devices 15, 16 are driven to rotate by pivotal movement of respectively the lid 10 and seat 11. For the lid 10, the driving mechanism takes the form of a pair of longitudinal splines 27 extending axially along the flanks of its damping device 15, as seen in FIG. 4, which are engaged in axially extending grooves 28 in the bore 21 of its respective hinge block 10b. These grooves 28 are deliberately designed to be wider in their circumferential extent than the splines 27, so as to act in the manner of a key and oversized keyway, so that the lid 10 will have a limited amount of freedom to rotate without also driving its damping device 15 to rotate. The driving mechanism thus incorporates a lost motion function, as can be understood from the sectional view shown in FIG. 11b. In practice, what this means is that the lid 10 is able to pivot freely through a certain angle towards its lower position before its damping device 15 is actuated.

A similar driving mechanism with a lost motion function is incorporated into the mounting of the seat 11. In this case, the damping device 16 has a pair of longitudinal splines 29 extending axially along its flanks, as seen in FIG. 5, which are engageable in axially extending grooves 30 in the bore of its respective hinge block 11b, which again are wider in their circumferential extent, as can be seen from the sectional view shown in FIG. 11d. In practice, this means that the seat 11 is able to pivot freely through a certain angle towards its closed position before its damping device 16 is actuated.

A further feature of the damping devices 15, 16 is that they both incorporate a series of circumferentially extending ribs 31, 32. The purpose of these ribs 31, 32 is to engage the bores of the respective posts 14a, 14b in which the damping devices 15, 16 are mounted, thus serving to centre the damping devices and hence assist their rotational movement. The action of the ribs 31, 32 can be understood from the sectional views seen in FIGS. 11a and 11c.

The damping device 15 seen in FIG. 4 is an integrated solution, with a specially designed cylinder 18 that incorporates the features of the camming surfaces 24, splines 27 and ribs 31 as an integral part of the device. An alternative solution, seen in FIG. 7, would be to incorporate the features of the camming surfaces 24′, splines 27′ and ribs 31′ in a specially designed sleeve 18′ which houses a damper 40. It would then be possible to use a standard damper 40. The same option also applies to the damping device 16 seen in FIG. 5.

FIG. 8 illustrates the point that the damping device could be designed with its driving mechanism arranged the other way round. Thus, instead of having splines to engage in grooves in the hinge block, here the device 50 incorporates grooves 51 to be engaged by splines or teeth in its respective hinge block.

It will be understood from the above that the damping devices 15, 16 form an integral part of the hinge assembly. Thus, the linear axes of the damping devices 15, 16 are arranged to be coincident with the axis 13 of the hinge assembly, as seen in FIG. 3, so that together they are able to form a fulcrum for the pivotal movement of the lid 10 and seat 11, in the manner of a hinge pin. It will be understood that for this purpose, the damping devices 15, 16 will have to have sufficient shear strength to support the pivotal movement of the lid 10 and the seat 11 and withstand forces acting upon them in use of the toilet.

In operation, as the lid 10 and/or seat 11 pivot from their raised position towards their lower position on the toilet 12, there will initially be no reaction from either damping device 15, 16 due to their lost motion mechanisms. On continued pivotal movement, the driving mechanisms will engage, causing rotation of the damping devices 15, 16. By the action of their movement converting mechanisms, rotation of the damping devices 15, 16 will cause axial displacement of their cylinders 18, 20. With the free ends of their piston rods 17, 19 abutting against the cover caps 23 of the seat hinge blocks 11a, 11b, the result will be compression of the damping devices 15, 16. Compression of the damping devices 15, 16 creates a damping reaction and this is transmitted back to the lid 10 and/or seat 11 as damped resistance to their pivotal movement.

In order to assist maintaining co-axial alignment of the hinge assembly, each post 14a, 14b is provided with an axially extending annular spigot 33. These are designed to be rotatably engageable in counterbores 34, 35 in the hinge blocks 10b and 11b of the lid 10 and seat 11. There is a similar arrangement of an annular spigot 36 being rotatably engageable in a counterbore 37 to act between the hinge blocks 10a, 11b of the lid 10 and seat 11. However, this only applies on one of the posts 14b: for assembly reasons, it cannot be used on both posts. Instead, on the other post 14a, an annular spacer 38 is interposed between the hinge blocks 10b and 11a of the lid 10 and seat 11. Preventing misalignment of the hinge assembly reduces wear and the chances of jamming, and promotes reliability and smooth operation of the hinge assembly.

To further enhance the integrity of the assembly, a support bar 39 is arranged to extend between the posts 14a and 14b. The support bar 39 in this case is provided as a separate component and is arranged to be attachable to the posts 14a, 14b, conveniently by a snap fit. The support bar 39 aids stability and helps maintain correct alignment of the hinge assembly.

To help keep the seat 11 in position on the toilet 12 in use, it is conveniently provided with spaced apart limit stops 41 to slidably engage the outer face of each of the posts 14a, 14b. The stops 41 act to centre the seat 11 and keep it in alignment on the toilet 12.

The idea of using the damping devices as an integral part of the hinging mechanism in the hinge assembly described above creates a neat solution and enables the number of component parts to be minimised.

It will be appreciated that the hinge assembly described above is suitable for use in other applications, including for example in a vertical alignment for hanging doors. In that case, the assembly could be used in the manner of a rising butt hinge and provide damping to the movement of the door as it falls and closes under the force of gravity. Alternatively, the assembly could be used in the manner of a normal swinging hinge and provide a damped resistive force to the closing movement of the door.

While the disclosed technology has been described with respect to a limited number of embodiments, those skilled in the art, having benefit of this disclosed technology, will appreciate that other embodiments can be devised which do not depart from the scope of the disclosed technology as disclosed herein. Accordingly, the scope of the disclosed technology should be limited only by the attached claims.

1. A damped hinge assembly for mounting a first member for rotational movement relative to a base member about a hinge axis, the assembly comprising:
a first linearly acting damping device, and
first camming means for converting rotational movement of the first member in a first direction into linear actuation of the first damping device to cause it to impart a damped resistive force to the first member over at least part of its movement in said first direction, wherein the first damping device is mounted with its linear axis coincident with the hinge axis, with the first damping device acting as a fulcrum for said rotational movement of the first member.

2. The assembly as claimed in claim 1 wherein the first camming means comprises at least one camming surface extending generally helically around said hinge axis.

3. The assembly as claimed in claim 2 and further mounting a second member for rotational movement relative to the base member about said hinge axis, wherein the assembly further comprises a second damping device for imparting a damped resistive force to the second member over at least part of its movement in said first direction.

4. The assembly as claimed in claim 3 wherein the second damping device is a linearly acting damping device.

5. The assembly as claimed in claim 4 wherein the second damping device is arranged with its linear axis coincident with said hinge axis so that it acts together with the first damping device as a fulcrum for said rotational movement of the first and second members.

6. The assembly as claimed in claim 5 and further comprising second camming means for converting rotational movement of the second member in said first direction into linear actuation of the second damping device.

7. The assembly as claimed in claim 6 wherein the second camming means comprises at least one camming surface extending generally helically around said hinge axis.

8. The assembly as claimed in claim 3 wherein the first and second damping devices are operable independently of each other.

9. The assembly as claimed in claim 8 wherein the first and second dampers are rotatably engaged in hinge blocks on their respective first and second members, and at least one of the members comprises limit stops for holding its position along the hinge axis.

10. The assembly as claimed in any claim 9 and further including drive mechanisms for transmitting rotational movement of the first and second members to their respective first and second damping devices.

11. The assembly as claimed in claim 10 wherein said drive mechanisms each include a lost motion device to allow a limited amount of free relative rotational movement between the first and second members and their respective first and second damping devices.

12. The assembly as claimed in claim 11 wherein the lost motion device includes the provision of at least one interengaging key and oversized keyway operating between the first and second members and their respective damping devices.
